(19) United States
(12) Patent Application Publication
(10) Pub. No.: US 2026/0330979 A1
(43) Pub. Date: Oct. 22, 2026

(54) A System and Method for Providing Reliable Aircraft Information from Air Band Data

(71) Applicant: Dorde Zekavica, Belgrade (RS)

(72) Inventor: Dorde Zekavica, Belgrade (RS)

(21) Appl. No.: 19/106,724

(22) PCT Filed: Aug. 14, 2023
(86) PCT No.: PCT/IB2023/058167

§ 371 Date: Feb. 26, 2025

(30) Foreign Application Priority Data
Aug. 26, 2022 (GB) 2212449.9

(51) Int. Cl. G08G 5/26; G08G 5/22; H04B 7/185; H04L 9/00

(52) U.S. Cl. CPC G08G 5/26; G08G 5/22; H04B 7/18506; H04L 9/50; H04L 2209/84

(57) ABSTRACT

Invention relates to a system and method of providing reliable aircraft information from air band data. The method comprises the steps of providing a plurality of ground-based nodes, each of which is operable to receive air band data from an aircraft within reception range, and a server in communication with each of the nodes; relaying air band data received from an aircraft at a plurality of the nodes to the server; using a consensus algorithm, performing a consensus check on the received air band data; storing the data that has passed the consensus check in a blockchain; displaying the data in the blockchain to end users. Air band data is crowdsourced and checked to see if it is authentic. The data is then provided on a blockchain for access by end users. This system and method provide a simple and secure way of verifying and sharing air band data.

This invention relates to a system and method for proving reliable aircraft information from air band data.

Air band data has been in use since the late 1970s as a useful way of tracking aircraft and monitoring the status of the aircraft before, during and after flight. Aircraft Communications Addressing and Report System (ACARS) and more recently, Automatic Dependent Surveillance—Broadcast (ADS-B) are two well-known formats of air band data that are used in the aviation industry.

ACARS is a digital datalink system for transmission of short messages between aircraft and ground stations via air band radio. ACARS is understood to be used for a plethora of different communications including 0001 events (Out of the gate, Off the ground, On the ground and Into the gate), flight management communications pertaining to, inter alia, flight plans and weather routing information, equipment status and maintenance data, as well as other message communications to and from the flight crew. ADS-B is a surveillance technology in which an aircraft determines its position and periodically broadcasts its location, thereby enabling the aircraft to be tracked.

There are numerous benefits to providing this air band data. First of all, it will enable the airlines to more efficiently analyse and organise their fleet resources, including scheduling, maintenance and fuel consumption, to name but a few. Secondly, the air band data allows air traffic controllers to more efficiently route aircraft in their airspace. The air band data is typically considered more accurate for precisely locating aircraft than radar, and this will enable the air traffic controllers to route the aircraft safely in closer proximity to each other in a more efficient manner. This in turn reduces flight times and fuel consumption. Thirdly, the air band data allows some mandatory International Civil Aviation Organisation (ICAO) functions within given reception range, such as aircraft tracking, through ADS-B and ADS-C. Fourth, the air band data allows other aircraft to detect the position of aircraft in their vicinity and significantly reduce the possibility of a mid-air collision with another aircraft.

In addition to the industry and safety benefits of air band data, it has been known to use the air band data for other commercial and non-commercial uses. For example, aircraft enthusiasts are known to use the air band data to track aircraft during flight. In addition, some commercial and non-commercial enterprises publish the data in a user-readable format, such as by plotting the location of the plane(s) on a map, so that the location of a plane may be tracked (effectively) in real time.

Although there are numerous benefits to the air band data and the open sharing of air band data, there are in fact numerous problems with the open nature of the air band data models. For example, there are serious concerns that the air band data is relatively insecure and is open to manipulation and/or falsification. In the article entitled “Air Traffic Control Systems Vulnerabilities Could Make for Unfriendly Skies” by Brian Prince dated Jul. 27, 2012, published in Security Week (www.securityweek.com) online edition, Researcher Andrei Costin identifies many of the shortcomings of the air band data systems. In summary, a lack of authentication and/or encryption leads to a system that is open to manipulation by unscrupulous third parties. Those third parties could intercept messages and indeed create “spoof” messages. For example, if a large volume of spoof messages were input into the system, this could bring the entire system to a standstill, creating havoc in air traffic control systems.

One solution that was proposed was to introduce encryption for the air band data messages. However, this introduces a layer of additional complexity, message transmission weight and expense, both monetarily, computationally and uses additional bandwidth space that is undesirable. Furthermore, introducing encryption reduces the accessibility of the system to smaller users, reducing uptake which will detract from its effectiveness.

It is an object therefore of the present invention to provide a system and method that overcomes at least some of the above-identified problems. It is a further object of the present invention to provide a system and method that provide a useful alternative choice for the consumer.

### SUMMARY

According to the invention there is provided a method of providing reliable aircraft information from air band data comprising the steps of: providing a plurality of ground-based nodes, each of which is operable to receive air band data from an aircraft within the ground-based nodes reception range, and a server in communication with each of the ground-based nodes over a communications network; the method further comprising the steps of:
registering each of the ground-based nodes with the server;
authenticating each of the ground-based nodes with the server;
authorizing communication of each of the ground-based nodes with the server;
relaying air band data received from an aircraft at a plurality of the ground-based nodes to the server;
the server, using a consensus algorithm, performing a consensus check on the received air band data received from the plurality of the ground-based nodes;
storing the air band data that has passed the consensus check in a blockchain; and
making the air band data stored in the blockchain available for display to end users.

By having such a method, the air band data may be “crowd-sourced” from a plurality of disparate ground-based nodes to confirm the veracity of the air band data. According to the method, it will be possible to accurately locate the origin of the air band data and the identity of the “feeder” of the air band data. This will prevent malicious air band data from being fed into the system and lead to a more safe and secure method. The data will be stored in a blockchain from where it will be secure, not open to manipulation by unscrupulous third parties, and can be made available to end users for their own uses.

In one embodiment of the invention there is provided a method of providing reliable aircraft information from air band data in which the method further comprises the step of preforming a reputation check of a ground-based node based on the message truthfulness in comparison to other nodes data and reception range. This is seen as a particularly effective way of performing a reputation check on the data received from each of the ground-based nodes that will strengthen the accuracy of the method and provide a method in which the data will be reliable.

In one embodiment of the invention there is provided a method of providing reliable aircraft information from air band data in which the step of storing the air band data that has passed the consensus check in a blockchain further comprises hashing the air band data and storing the message hash in the blockchain; and thereafter making the hash of the air band data available for display to end users. This will lead to a method that is more secure, more efficient from a storage resource point of view and easier to navigate.

In one embodiment of the invention there is provided a method of providing reliable aircraft information from air band data in which the consensus check performed on the received air band data further comprises a location check on the received air band data. This is seen as a particularly preferred embodiment of the present invention. By performing a location check on the received air band data, it is possible to detect with a high degree of certainty the precise location of the aircraft and also whether or not the data being fed is real or malicious. If the location check does not indicate that the message is coming from an aircraft, the data may be flagged and disregarded with ease.

In one embodiment of the invention there is provided a method of providing reliable aircraft information from air band data in which the consensus check performed on the received air band data further comprises an identity check on a feeder of the air band data. This is seen as a particularly effective method of operating the invention. By incorporating an identity check, it will be possible to determine whether or not the source of the data is a trusted source. If so, the data is less likely to from a nefarious source.

In one embodiment of the invention there is provided a method of providing reliable aircraft information from air band data in which the step of making the air band data stored in the blockchain available for display to end users comprises providing a web application and a web page populated with at least some of the air band data. This is seen as a particularly effective way in which the air band data can be made available to end users. All the end users will require is a web browser to access the data.

In one embodiment of the invention there is provided a method of providing reliable aircraft information from air band data in which the method comprises providing a plurality of web pages each populated with at least some of the air band data and providing access to one or more of the web pages to different end users.

Again, this is seen as useful as different users may have different levels of access to the data, and different data may be presented to different users. For example, a typical user may simply wish to see if their family members flight is on schedule and when it is likely to arrive. Alternatively, a flight enthusiast may wish to have more detail including the specifications of the aircraft, their cruising altitude, air speed and the like. Further still, a commercial operator may wish to see weather events for weather routing purposes, or other information pertaining to the aircraft such as equipment malfunction or alarm notifications so that they can smoothly operate their aircraft, or fuel consumption information so that they can train their flight crews appropriately and share better flying techniques.

In one embodiment of the invention there is provided a method of providing reliable aircraft information from air band data in which the method comprises plotting the location data on a map for subsequent display on an end user's user interface.

In one embodiment of the invention there is provided a method of providing reliable aircraft information from air band data in which the method comprises the step of transmitting encoded air band data to the server and thereafter decoding the air band data received at the server prior to performing a consensus check on the received air band data. In this way, a large amount of computational burden will be removed from the remote ground-based nodes, providing for a simple, more cost-effective ground-based node.

In one embodiment of the invention there is provided a method of providing reliable aircraft information from air band data in which the step of using a consensus algorithm to perform a consensus check on the received air band data comprises comparing reception of the air band data under pre-defined conditions for time reception. This is seen as a particularly useful way of determining the veracity of the air band data and whether or not it is being transmitted from an aircraft, and whether or not it is reliable.

In one embodiment of the invention there is provided a method of providing reliable aircraft information from air band data in which the step of authenticating each of the ground-based nodes with the server comprises implementing a self-sovereign identity technique. This is seen as a simple yet effective way to provide the authentication that will be supported by the blockchain architecture.

In one embodiment of the invention there is provided a method of providing reliable aircraft information from air band data in which the received air band data comprises both ACARS and ADS-B band data. This is seen as useful as the system will not be limited to one or the other types of air band data but instead will be able to gather more information about the aircraft and have wider application and appeal. It is envisaged that other types of air band data, other than ACARS and ADS-B, could also be captured if desired.

In one embodiment of the invention there is provided a method of providing reliable aircraft information from air band data in which the received air band data comprises radio data other than ACARS and ADS-B band data.

In one embodiment of the invention there is provided a system for providing reliable aircraft information from air band data comprising:
a plurality of geographically-spread ground-based nodes, each ground-based node having an air band receiver for receiving air band data, means for providing a geolocation of the node, a transmitter for transmitting received air band data to a remote server over a communication network;
a server having: a receiver for receiving the air band data from each of the plurality of geographically-spread ground-based nodes over the communication network; a processor for processing the air band data including, using a consensus algorithm module, performing a consensus check on the received air band data received from a plurality of the ground-based nodes to authenticate the air band data;
a blockchain for storage of the authenticated air band data;
a web application for relaying the authenticated air band data to an end user for display on an end user device.

This is seen as a particularly simple architecture of system to establish and operate. The system will allow for the crowdsourcing of air band data and this data may be checked, verified and shared with end users if found to be true. Furthermore, the reliable data that may be trusted by end users is stored in a secure manner, while being readily available to share with end users.

In one embodiment of the invention there is provided a system for providing reliable aircraft information from air band data in which the server has a hashing algorithm module for hashing the air band data prior to storage of the hashed authenticated air band data in the blockchain.

In one embodiment of the invention there is provided a system for providing reliable aircraft information from air band data in which the server has a decoder for decoding the received air band data.

In one embodiment of the invention there is provided a system for providing reliable aircraft information from air band data in which the server has an identity module for verifying the identity of a feeder of air band data.

In one embodiment of the invention there is provided a system for providing reliable aircraft information from air band data in which the identity module uses a self-sovereign identity technique to identify the feeder of air band data.

In one embodiment of the invention there is provided a system for providing reliable aircraft information from air band data in which the consensus algorithm module further comprises a location confirmation module.

In one embodiment of the invention there is provided a system for providing reliable aircraft information from air band data in which there are provided a plurality of web pages, each populated with at least some of the air band data and there is provided means to selectively provide access to one or more of the web pages to different end users.

In one embodiment of the invention there is provided a system for providing reliable aircraft information from air band data in which there is provided means to plot the location data on a map for subsequent display on an end user's user interface.

In one embodiment of the invention there is provided a system for providing reliable aircraft information from air band data in which the air band receiver is a multi-band air band receiver operable to receive ACARS and ADS-B band data.

In one embodiment of the invention there is provided a system for providing reliable aircraft information from air band data in which the air band receiver is a multi-band air band receiver operable to receive radio data other than ACARS and ADS-B band data.

In one embodiment of the invention there is provided a system in which the means for providing the geolocation of the node comprises one or more of a global navigation satellite system (GNSS) chip and a WiFi based location service.

### DETAILED DESCRIPTION OF THE INVENTION

The invention will now be more clearly understood from the following description of some embodiments thereof given by way of example only with reference to the accompanying drawings, in which:—

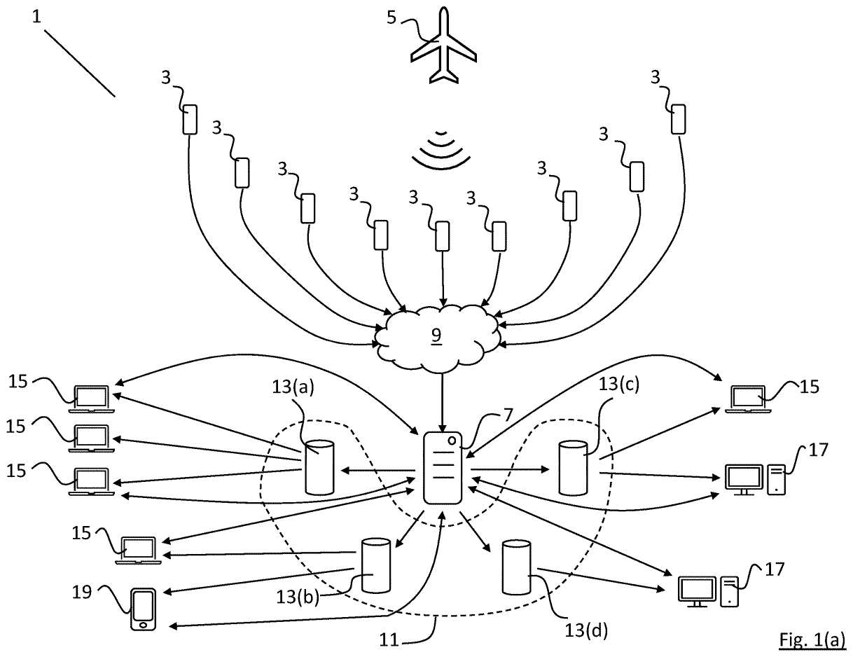

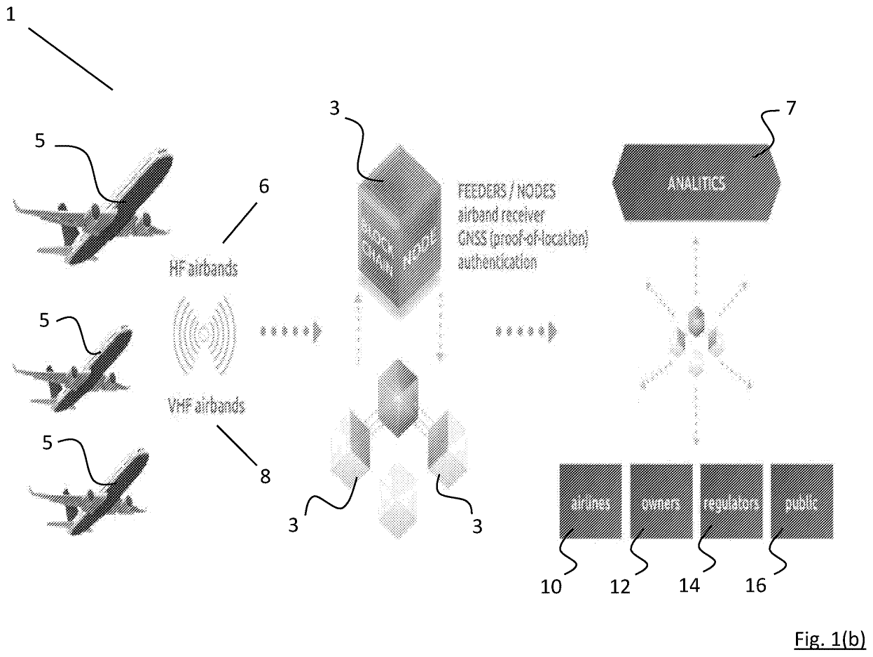

FIG. 1(a) is a diagrammatic representation of a system according to the invention;

FIG. 1(b) is a diagrammatic representation of the system similar to FIG. 1(a);

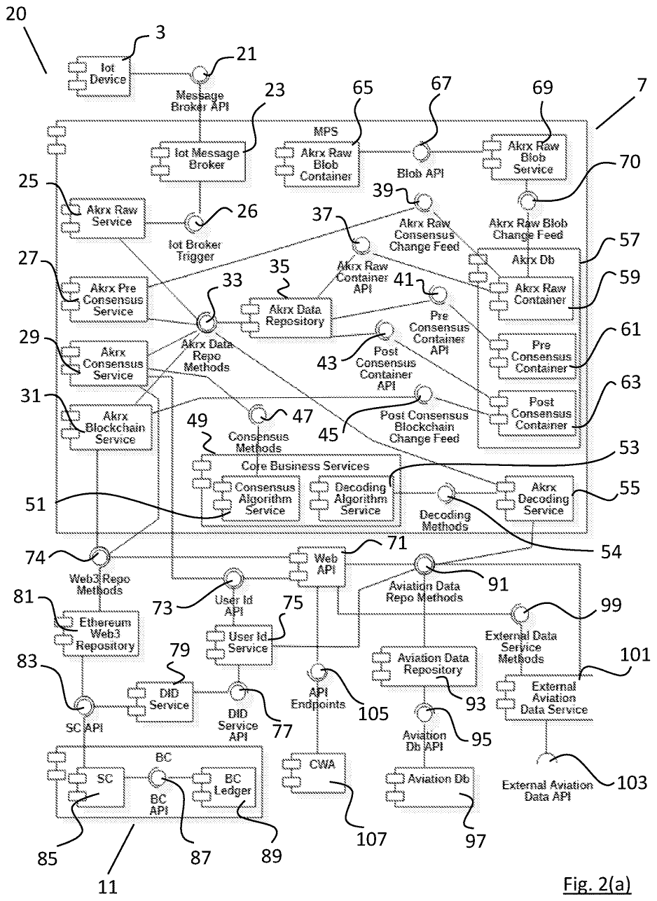

FIG. 2(a) is a component diagram of the system architecture;

FIG. 2(b) is a deployment diagram of the system architecture;

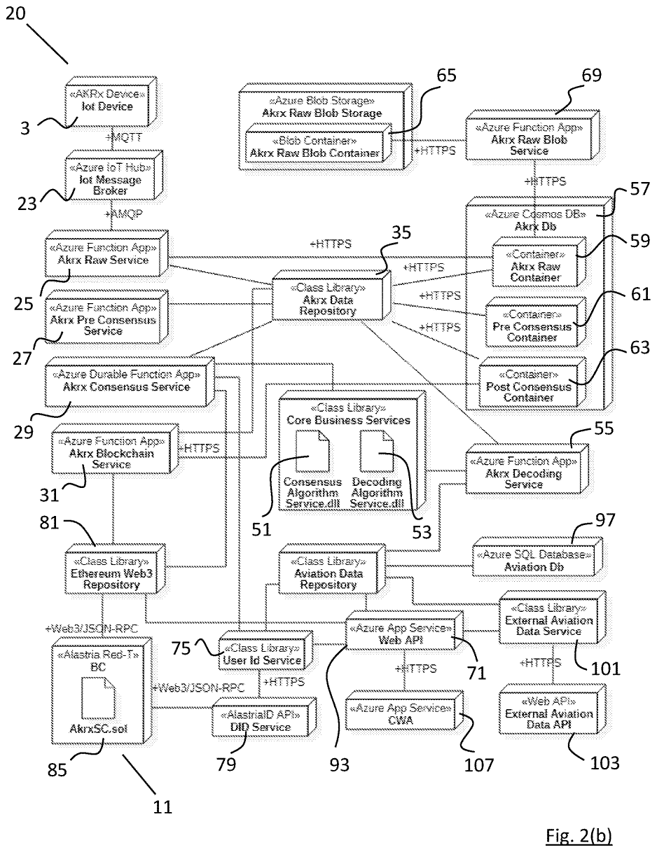

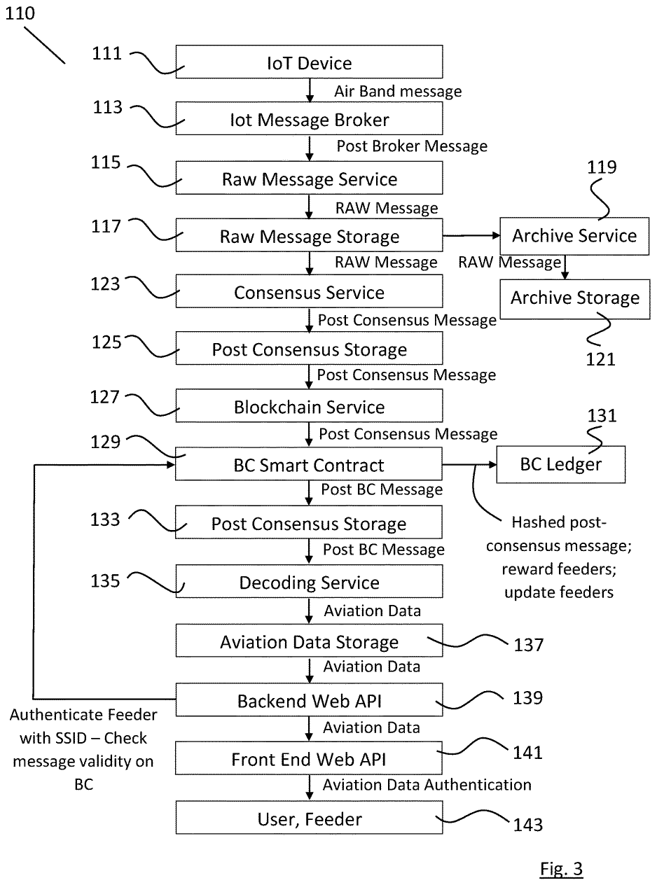

FIG. 3 is a flow diagram of the method of processing air band data;

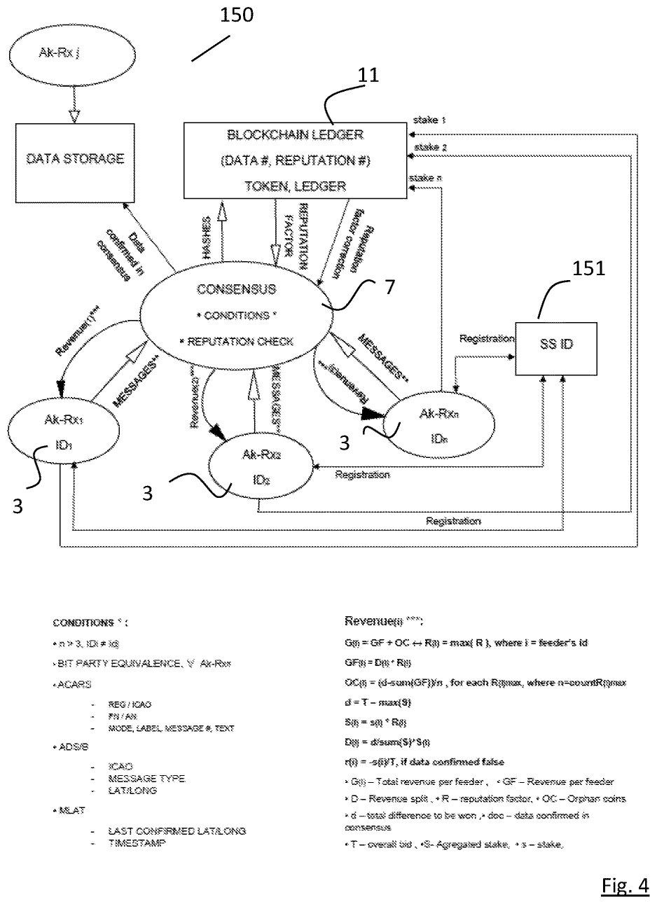

FIG. 4 is a diagrammatic representation of the consensus management procedure; and

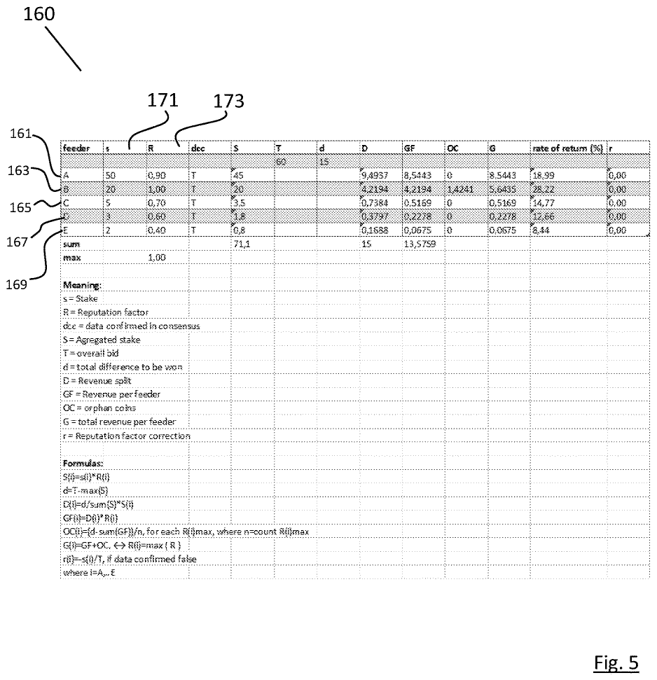

FIG. 5 is a spreadsheet illustrating the rewarding procedure used as part of the consensus management procedure.

Referring to FIG. 1(a), there is shown a diagrammatic representation of a system, indicated generally by the reference numeral 1, in which the method according to the invention may be performed. The system comprises a plurality of ground-based nodes 3, each of which is operable to receive air band data from an aircraft 5. The system 1 further comprises a server 7 in communication with each of the ground-based nodes 3 via a communications network 9, in this case the internet. The server 7 is in turn in communication with a distributed ledger, referred to as a blockchain 11, represented by way of remote accessible memory units 13(a)-13(d). Finally, a plurality of computing devices including laptops 15, personal computers (PCs) 17 and a smartphone 19 are able to access one or both of the server 7 and the blockchain 11.

Each of the ground-based nodes 3 comprises a multi-band antenna, capable of receiving ACARS and ADS-B air band data, a global navigation satellite system (GNSS) component operable to determine the location of the ground-based node and to provide a common time clock for all of the ground-based nodes, and a transmitter for transmitting received air band data to the remote server 7 over the communication network 9. The server 7 in turn comprises a receiver for receiving the air band data from each of the plurality of geographically-spread ground-based nodes 3 over the communication network 9, a processor for processing the air band data including a consensus algorithm module. The receiver comprises a module or a service with a function to receive data/air band data.

In the embodiment shown, only one aircraft 5 has been illustrated for conciseness and to avoid confusion however it will be understood from the following description that the system will be operable to monitor a plurality of aircraft simultaneously. Furthermore, the blockchain 11 (represented in dashed outline) has been represented by four remote accessible memory units 13(a)-13(d) however this is not deemed limiting. As will be understood, the blockchain can and almost certainly will be spread over a far greater number of remote accessible memory units.

In use, as an initial step, each of the ground-based nodes 3 will be registered with the server 7 and the ground-based node will be linked to a feeder using their digital identity. Preferably, the method uses a self-sovereign identity technique to identify the ground-based nodes 3. The aircraft 5 broadcasts one or both of ACARS and ADS-B air band data and this broadcast is received by a plurality of the ground-based nodes 3 that are in range of the broadcast and capable of picking it up. Each of the ground-based nodes 3 that received the broadcast will then transmit the air band data to the remote server 7 over the communications network 9.

Upon receipt, the server 7 will authenticate the air band data using self-sovereign identity, and will perform a consensus check on the received air band data received from the plurality of the ground-based nodes. The consensus check entails the following steps: First of all, the server 7 will check the identity of the ground-based nodes 3 that are sending the air band data to the server 7 using an identity module, and the server 7 will check the location of each of the ground-based nodes 3 that transmitted the air band data. A record of each of the ground-based nodes 3 is stored in the blockchain 11 and the server 7 will check in the blockchain 11 to see whether or not there is a record of each of the ground-based nodes 3 therein. If there is no record of one or more of the ground-based nodes 3 present in the blockchain 11, the data from that ground-based node 3 can be disregarded as untrustworthy. Furthermore, when a new device is being deployed, the feeder will have to register using SSID functionality, which is based on the blockchain technology. After that, feeders get a security token that are contained within messages for authentication in the future. The procedure for consensus check will be described in more detail below with reference to FIG. 4.

Furthermore, the server 7 will carry out the consensus check by comparing the reception of the air band data, received by a plurality of the ground-based nodes 3, under pre-defined conditions for time reception. As will be understood, the server 7 knows the location of each of the ground-based nodes 3 from their GNSS data, and therefore if a signal is received by a ground-based node 3, the server is able to determine the maximum expected time delay it will take for the signal to arrive at another ground-based node 3. More specifically, the server should be able to extrapolate the time delta (the difference in time that it takes for the signal to be received at a first given ground-based node 3 having been received at a second ground-based node 3). If two or more aircraft receivers are within the range of a certain transmitted message, they will receive the identical message. Reception of the same message by multiple receivers, with certain position difference can be used for building the consensus algorithm. As the aircraft moves through the sky, its position relative to the plurality of ground-based nodes 3 will alter over time and this can be used to track the progression of the plane over time and also to calculate whether or not it is in fact a plane that is being tracked or if the transmission is from a malicious source.

The server uses a consensus algorithm to determine whether the air band data received by each of the ground-based nodes 3 is legitimate and reliable. If not, the air band data is discarded. On the other hand, if it is determined that the air band data is reliable, the server 7 decodes the air band data and creates a hash of the air band data. The server 7 then stores the hash of the air band data in the blockchain 11. A direct link is shown between the server 7 and the blockchain 11 memory components 13(a), however the communication may also, and almost certainly will, be routed through the internet 9.

Finally, once the air band data has been verified, end users may access the data from their devices including laptops 15, PCs 17, and/or smart phone 19. Different users may prefer to use different devices, particularly depending on the information that they are trying to glean from the system and the level of detail required. A web application will be provided to allow access to the data in the blockchain by the devices 15, 17, 19. One or more web applications may be provided to provide different levels of access to different users. For example, commercial users may require detailed information concerning the sensors on the aircraft whereas more casual users may simply wish to see the aircraft's position superimposed on a map.

In the embodiment shown, end users are shown to access the data from their devices including one or more of a laptop 15, a PC 17 or a smartphone 19. It will be understood that this is not deemed limiting and indeed other computing devices with sufficient computing power could be used to access the data, including, but not limited to, a tablet, a phablet, a personal digital assistant (PDA), an internet enabled TV, a gaming device or other device capable of receiving and relaying the information to the user.

Referring now to FIG. 1(b), there is shown a diagrammatic representation of the system 1 similar to FIG. 1(a), where like parts have been given the same reference numeral as before, in which the method according to the invention may be performed. The system 1 again comprises a plurality of ground-based nodes 3, each of which is operable to receive air band data from one of a plurality of aircraft 5 (in this case, three aircraft are illustrated but again, many more aircraft will be tracked in practice) over high frequency (HF) airbands 6 or very high frequency (VHF) airbands 8 and to convey the information to the blockchain. The data is analysed in server 7 and thereafter shared with end users which include, inter alia, airlines 10, owners 12, regulators 14 and/or the general public 16.

Effectively, the concept of the system is to have IoT sensors on the ground that feed the network. The system and method are effectively developing a public permissioned blockchain. Each feeder needs to be authenticated and authorized by the system in order to be able to feed the data, and consequently to be eligible for consensus algorithm consideration. Backend cloud application (BCA) should perform a consensus algorithm and deduce a truthful message, when received from several (n>3) AKRx devices (ground-based nodes 3). (By having n>3, the method and system attempt to align with Byzantine Fault tolerance (BFT) which is required in consensus agreement. In principle, to reach consensus between true, malicious and non-feeding nodes, the minimum number of nodes that are required is n=3f+1. Therefore, as a minimum, n>3, assuming f=1. This assumption can be made under the condition that there are two other levels of protection, in this case SSID and GNSS (or other geolocation methodology) as well as a reputation measurement). By implementing a digital/self-sovereign identity model for each feeder to the system (Alastria ID or similar), the method and system are aware of each and every contributor to the system. One self-sovereign ID can have multiple sensors/AKRx devices, as long as the location of sensors provided by two location check systems (the AKRx device has a GNSS chip, utilizes Mozilla Location Service and/or other type of geolocation) are not within the overlapping radius, which can be seen in multiple identical messages from the same SSID. Sensors per a single self-sovereign ID cannot give the same ACARS, ADS-B or multi-lateration messages, but unique ones only, which is a way to control that at a location there is no tampering with the system.

Referring now to FIG. 2(a), there is shown a component diagram of the system architecture, indicated generally by the numeral 20, including the various modules and components of the system. The system 20 comprises an Internet of Things (IoT) device, namely the ground-based node 3, only one of which is shown. The IoT device is connected to the server 7 via a message broker API 21. RAW service module 25 implements an IoT Broker trigger 26 which is triggered every time a message (air band data) is received by IoT message broker 23. RAW service module 25 then stores raw messages to Akrx Raw Container 59 of the database Akrx Db 57, using Akrx Data Repo Methods 33 which are exposed by the service Akrx Data Repository 35. Akrx Data Repo Methods 33 in turn, use Akrx Raw Container API 37 to store messages to Akrx Raw Container 59.

Akrx Pre-Consensus Service 27 gets the messages immediately after they have been stored to Akrx Raw Container 59, using Akrx Raw Consensus Change Feed 39 and stores them to Pre-Consensus Container 61, using Akrx Data Repo Methods 33 of Akrx Data Repository 35. Pre-Consensus Container 61 is a temporary container where messages exist only until consensus algorithm is executed on them.

Akrx Consensus Service 29 periodically takes a batch of messages from Pre-Consensus Container 61, using Pre-Consensus Container API 41, executes consensus algorithm, using Consensus Methods 47 implemented by Consensus Algorithm Service 51, to determine the resulting single version of truth message for the messages received from multiple ground-based nodes, and stores that resulting message to Post-Consensus Container 63, using Post-Consensus Container API 43. Previously described operations of Akrx Consensus Service 29 are done using Akrx Data Repo Methods 33 of Akrx Data Repository. Consensus Algorithm Service 51 is a part of Core Business Services 49 component, the purpose of which is to keep the most important know-how business services.

Akrx Blockchain Service 31 gets the messages immediately after they have been stored to Post-Consensus Container 63, using Post-Consensus Blockchain Change Feed 45 and uses Web3 Repo Methods 74 implemented by Ethereum Web3 Repository 81 to send the hash of the resulting single version of truth message, along with identities of all of the feeders who sent that message to the server (true or false), to the SC 85 (Smart Contract), using SC API 83. SC 85 stores message hash on BC (Blockchain) Ledger 89, using BC API 87. SC 85 uses DID (Digital Identity) Service 79 to identify Feeders who will be rewarded for sending the true version of the message. DID Service 79 is through DID Service API 77 connected with User Id Service 75, which is central server identity management service. User Id Service 75 implements User Id API 73, which is used by every other system component which needs identity functionalities: AkrxConsensus Service 29, Web API 71.

After message hash is stored on the BC Ledger 89, SC 85, through SC API 83 returns the BC address of hashed message to Akrx Blockchain Service 31, which then, using Akrx Data Repo Methods 33 of Akrx Data Repository 35, updates Post-Consensus Container 63 records with that information. At that moment messages from Post-Consensus Container 63 are ready for Akrx Decoding Service 55, which takes the messages from Post-Consensus Container 63, using Akrx Data Repo Methods 33 of Akrx Data Repository 35, decodes them using Decoding Methods 54 implemented by Decoding Algorithm Service 53 and stores decoded data to Aviation Db 97, through Aviation Db API 95, using Aviation Data Repo Methods 91 implemented by Aviation Data Repository 93. Decoding Algorithm Service 53 is a part of the Core Business Services 49 component.

Web API 71 is the main backend API which provides all the necessary API Endpoints 105 to the frontend web application CWA (Commercial Web Application) 107. Web API 71 uses Aviation Data Repo Methods 91 as an interface to Aviation Data Repository 93 to be able to use decoded aviation data stored in Aviation Db 97. Web API 71 also may use any External Aviation Data API 103, using External Data Service Methods 99 implemented by External Aviation Data Service 101.

For the purpose of archiving, raw messages are transferred from the Akrx Raw Container 59 to Akrx Raw Blob Container 65, through it's Blob API 67, using Akrx Raw Blob Change Feed 70, which triggers Akrx Raw Blob Service 69 which then executes the transfer.

MPS (Message Processing Service) encompasses all the components responsible for message processing, from the Message Broker API 21 provided by IoT Message Broker 23, to the Akrx Blockchain Service 31 where the resulting message is ready to be sent to Blockchain, and Akrx Decoding Service 55 where the message is decoded and ready to be sent to the database (Aviation Db 97), as shown in FIG. 2(a).

It will be understood that various modifications could be made to the above structure without departing from the scope of the present invention and the above is an example of one architecture that would provide a workable solution. For example, instead of a DID, a Self Sovereign identification (SSID) could be used to good effect.

Referring to FIG. 2(b), there is shown a simplified diagrammatic representation of the system architecture as illustrated in FIG. 2(a), where like parts have been given the same reference numeral as before. Throughout the drawings and the specification referring to FIGS. 2(a) and 2(b) in particular, a number of abbreviations have been used to identify the components of the system. A list of the abbreviations is detailed in Appendix 1 below as follows:

APPENDIX 1
Abbreviations

| | |
|---|---|
| AA | Aviation Analytics |
| ACARS | Aircraft Communications Addressing and Reporting System |
| ACSO | Actor Requests the system to perform a software System Operation |
| ADS-B | Automatic Dependent Surveillance - Broadcast |
| ADS-C | Automatic Dependent Surveillance - Contract |
| AES | Advanced Encryption Standard |
| AKRx | Multi-band air-band radio receiver - (also referred to as “data feeders”, |
| | “data miners”, “IoT sensors”) |
| AOC | Airline Operational Communications |
| ANSP | Air navigation services provider |
| API | Application Programming Interface |
| ARING | Aeronautical Radio INC |
| APISO | Actor Prepares the Input parameters for the software System |
| | Operation |
| APNO | Actor Performs a Non-system Operation |
| BC | Blockchain |
| BCA | Backend cloud application |
| CI/CD | Continuous integration/continuous deployment |
| CID | Content Identifier |
| CLI | Command Line Interface |
| CSP | Communication Service Provider |
| CWA | Commercial Web Application |
| DID | Digital (Distributed, Decentralized) Identity |
| DB | Database |
| EASA | European Union Aviation Safety Agency |
| ECSS | European Cooperation for Space Standardization |
| ECDS | Elliptic Curve Digital Signature Algorithm |
| ECDH | Elliptic Curve Diffie-Hellman |
| FAA | Federal Aviation Administration |
| FAP | Front-end application |
| GNSS | Global Navigation Satellite System |
| GPIO | General Purpose Input/Output |
| ICAO | International Civil Aviation Organization |
| IETF | Internet Engineering Task Force |
| IPFS | Interplanetary File System |
| IOT/IoT | Internet Of Things |
| JWT | JSON Web Token |
| MCC | Multi Crew Coordination, Maintenance Control Center |
| MPS | Message Processing Service (IoT Hub, Azure functions, Cosmos DB) |
| MRO | Maintenance, Repair and Overhaul |
| MVP | Minimum Viable Product |
| OA | The software system sends to the actor the results, Output Arguments, |
| | proof of system operation execution |
| OASIS | Organization for the Advancement of Structured Information Standards |
| OEM | Original Equipment Manufacturer |
| OS | Operating System |
| PCB | Printed circuit board |
| PAAS | Platform as a service |
| PII | Personally identifiable information |
| POV | Proof-of-validity |
| POS | Proof of stake |
| POL | Proof-of-location |
| RF | Radiofrequency |
| SAS | Shared Access Signature |
| SAAS | Software as a service |
| SBC | Single Board Computer |
| SC | Smart Contract |
| SDR | Software Defined Radio |
| SITA | Société Internationale de Télécommunications Aéronautiques |
| SO | Software system Operation |
| SOC | System Operation Contract |
| SS | Software System |
| SSD | System Sequence Diagrams |
| SSI/SSID | Self Sovereign Identity |
| UC | Use Case |

In addition, throughout the drawings and FIGS. 2(a) and 2(b) in particular, a number of components of the system have been identified. A list of the components and their function along with a description of the component/component function is provided below as follows:

| No. | Component | Functionalities | | Description |
|---|---|---|---|---|
| 1 | Akrx Blockchain | 1. | Sends data to SC | After consensus has executed, |
| | Service | | | sends resulting data to SC, using |
| | | | | Web3 library |
| 2 | Akrx Data | 1. | Data Models for | Provides all Model Classes for the |
| | Repository | | MPS | whole MPS and Data Access |
| | | 2. | Data Access for | methods for all containers used in |
| | | | Akrx Db | MPS |
| 3 | Akrx Db | 1. | NoSQL Storage for | Provides fast, low-latency NoSQL |
| | | | messages which are | storage for all necessary stages of |
| | | | not yet decoded | messages during message |
| | | | | processing, until they are decoded |
| 4 | Akrx Decoding | 1. | Decodes data | Extracts useful data (key-value |
| | Service | 2. | Inserts data to | pairs) from all types of received |
| | | | Aviation Db | messages: ACARS, ADSB, MLAT, |
| | | | | using Decoding Algorithm library |
| | | | | and inserts decoded data to |
| | | | | Aviation Db, using Aviation Data |
| | | | | Repository library |
| 5 | Akrx Consensus | 1. | Executes | Executes consensus algorithm on |
| | Service | | consensus | pre-consensus data, using |
| | | 2. | Inserts data to Akrx | Consensus Algorithm library, User |
| | | | Db | Id Service Library and Ethereum |
| | | | | Web3 Repository (we need |
| | | | | Feeder's reputation and token |
| | | | | balance as a stake-deposit to be |
| | | | | eligible for participating in |
| | | | | consensus) |
| 6 | Akrx Pre | 1. | Gets raw received | Gets raw messages as soon as |
| | Consensus Service | | data | they are received to Akrx Raw |
| | | 2. | Inserts raw data to | Container, using Change Feed |
| | | | Pre-Consensus | functionality of Db provider and |
| | | | Container | inserts messages to Pre- |
| | | | | Consensus Container which will be |
| | | | | the main working playground for |
| | | | | Akrx Consensus Service |
| 7 | Akrx Raw Blob | 1. | Cold storage for raw | We use Blob Storage as cold |
| | Container | | data | storage (rarely used for auditing |
| | | | | purposes) for the purpose of |
| | | | | archiving all messages from all |
| | | | | Feeders in raw form, before |
| | | | | consensus execution |
| 8 | Akrx Raw Blob | 1. | Gets raw received | Gets raw messages as soon as |
| | Service | | data | they are received to Akrx Raw |
| | | 2. | Inserts data to cold | Container, using Change Feed |
| | | | storage | functionality of Db provider and |
| | | | | inserts messages to Blob Storage |
| | | | | in JSON format |
| 9 | Akrx Raw | 1. | Storage for raw data | NoSQL Db container that stores |
| | Container | 2. | Enables Change | raw messages as they are being |
| | | | Feed functionality | transferred by IoT Message broker. |
| 10 | Aviation Db | 1. | Storage for aviation | Relational Database for decoded |
| | | | data | data, statistics, analytics, external |
| | | | | third-party data, user identity |
| | | | | management |
| 11 | Aviation Data | 2. | Data Models for all | Provides all Model Classes for all |
| | Repository | | aviation data | aviation data and Data Access |
| | | 3. | Data Access for | methods for Aviation Db |
| | | | Aviation Db | |
| 12 | BC Ledger | 1. | Stores hashed | An immutable storage for: smart |
| | | | results of | contracts, hashes of messages |
| | | | consensus. | which are results of consensus, |
| | | 2. | Stores transactions | transactions and balances of |
| | | | and balances of | Feeders, Feeder's digital IDs, |
| | | | tokens for Feeders. | hashes of Feeder's credentials, |
| | | | | credential presentations. |
| 13 | Consensus | 1. | Consensus | Implementation of Consensus |
| | Algorithm Service | | algorithm business | algorithm logic |
| | | | logic | |
| 14 | Core Business | 1. | The most important | Provides Consensus Algorithm and |
| | Services | | business know-how | Decoding Algorithm as the central |
| | | | services | business know-how services of |
| | | | | MSP |
| 15 | CWA | 1. | User registration | Frontend application created in |
| | | 2. | User log in | React.JS which enables users to |
| | | 3. | Buy products | perform the listed functionalities. All |
| | | 4. | Data filtering | functionalities are realized in |
| | | 5. | Feeder registration | communication with Web API |
| | | 6. | Feeder Account | endpoints through http requests. |
| | | | overview. | |
| | | 7. | Administrator Log in | |
| | | 8. | BC statistics | |
| | | 9. | Show feeders | |
| | | 10. | Delete feeder | |
| 16 | Decoding Algorithm | 1. | Decoding algorithm | Implementation of Decoding |
| | Service | | business logic | algorithm logic |
| 17 | DID Service | 1. | Provides Self- | |
| | | | Sovereign Identity | |
| | | | services | |
| 18 | Ethereum Web3 | 2. | Provides methods to | |
| | Repository | | communicate with | |
| | | | SC | |
| 19 | External Aviation | 1. | Gets external third- | Service for getting the data from |
| | Data Service | | party data | external third-party sources |
| | | | | through their Web APIs, which is |
| | | | | complementary to the data which |
| | | | | we gathered by our IoT devices |
| 20 | Iot Message Broker | 1. | Message broker | Able to receive large amount of IoT |
| | | | | messages from IoT devices, using |
| | | | | secure protocols and transfer data |
| | | | | to numerous types of other |
| | | | | services, endpoints |
| 21 | IoT device | 1. | Receives messages | |
| | | | from aircraft | |
| | | 2. | Demodulates | |
| | | | messages | |
| | | 3. | Sends messages to | |
| | | | the cloud message | |
| | | | broker | |
| | | 4. | Can connect to | |
| | | | Ethernet and Wi-Fi | |
| 22 | MPS | 1. | Receives messages | We use MSP as a logical wrapper |
| | | | from IoT devices | component for all components that |
| | | 2. | Stores pre- | take part in processing of |
| | | | consensus and | messages from the reception in |
| | | | post-consensus | IoTMessage Broker, up to the |
| | | | data to NoSQL Db | transfer to SC on BC |
| | | 3. | Stores raw | |
| | | | messages to cold | |
| | | | storage | |
| | | 4. | Executes | |
| | | | consensus | |
| | | 5. | Sends consensus | |
| | | | results to BC | |
| | | 6. | Decodes data | |
| | | 7. | Stores decoded | |
| | | | data to Aviation | |
| | | | SQL Db | |
| 23 | Pre Consensus | 8. | Storage for pre- | NoSQL Db container that stores |
| | Container | | consensus data | raw messages which will be the |
| | | | | object of consensus execution |
| 24 | Post Consensus | 9. | Storage for raw data | NoSQL Db container that stores |
| | Container | 10. | Enables Change | messages which are results of |
| | | | Feed functionality | consensus execution. Needs to |
| | | | | have Change Feed functionality to |
| | | | | trigger Akrx Blockchain Service as |
| | | | | soon as message is inserted to |
| | | | | Post Consensus Container |
| 25 | SC | 1. | Stores consensus | SC will perform all the listed |
| | | | resulting message | functionalities. |
| | | | hash on blockchain | |
| | | | ledger | |
| | | 2. | Manages | |
| | | | transactions and | |
| | | | balances of tokens | |
| | | | for Feeders | |
| | | 3. | Manages total | |
| | | | amount of sent | |
| | | | messages for | |
| | | | Feeders | |
| | | 4. | Manages reputation | |
| | | | of Feeders | |
| 26 | User Id Service | 1. | Handles User | Provides: Authentication, |
| | | | Identity | Authorization, Users, Roles. |
| | | | Management | Connects User Id with Digital ID |
| | | | | and IoT device Id |
| 27 | Web API | 1. | Provides REST API | |
| | | | endpoints for | |
| | | | aviation data, | |
| | | | statistics, analytics, | |
| | | | user identity | |
| | | | management etc. | |

Referring now to FIG. 3, there is shown a flow diagram of the method of processing air band data, indicated generally by the reference numeral 110. The method comprises the initial step 111 of an IoT device transmitting an air band message to an IoT message broker. The IoT message broker processes the message in step 113 and passes the post-broker message to the RAW message Service. In step 115, the Raw message service processes the post-broker message and sends a RAW message to the RAW message storage. The RAW message is stored in RAW message Storage in step 117 before a copy of the RAW message is sent to the Archive Service in step 119 for subsequent storage in an Archive storage in step 121, while a second copy of the RAW message is passed to the Consensus service for processing in step 123.

Once the consensus service has processed the RAW message in step 123, a post consensus message is transmitted to the post consensus storage in step 125 and from there, the post consensus message is passed in step 127 to the blockchain service. The post consensus message is passed from the blockchain service to the blockchain smart contract in step 129, wherein a hashed post consensus message is sent to and stored in the Blockchain ledger in step 131. At approximately the same time, the feeders are rewarded with tokens and the feeders reputation record is updated. Once the post consensus message has been passed to the blockchain smart contract, a BC (blockchain) message address is returned back to the post consensus storage in step 133. The post blockchain message is then sent from storage to a decoding service 135 whereafter aviation data is sent to aviation data storage in step 137. The aviation data 137 is thereafter shared with a backend Web API in step 139. In step 139, the backend web API service will authenticate the feeder of the air band data using their SSID and are able to check the message validity on the blockchain. Backend Web API then makes aviation data available to the frontend web app in step 141. Frontend web app provides User, Feeder with the GUI interface to explore Aviation Data and to authenticate themselves to the system.

Referring to FIG. 4, there is shown a diagrammatic representation of the consensus management procedure, indicated generally by the reference numeral 150. Each aircraft (not shown) monitored through the ACARS system provides registration, flight number, exact departure and destination, time of departure, and other information that may be used in definitions of consensus. With the calculation of possible paths for a certain registration and flight number, flight time, previous ADS-B message check and sequence of ACARS messages (proof of validity), the method according to the present invention can isolate malicious actors in the system when a change in any of the above is made.

For example, if a malicious actor wants to spoof a message of an aircraft on the ground ready to take off from Athens to Frankfurt, he would need to provide a set of information that, if not already possible to be detected by other feeders from Athens reception area, on the flight path any spoofed message information, as a discrepancy, would be automatically visible and detected. The method ensures that any location tampering is not possible due to direct redundancy (ADS-B and MLAT), as well as technical or operational condition messages which are repeatable but not on the same geographical location. If such a case becomes evident, the method and system will know who the actors sending non-equivalent messages were, their reputation is reconsidered and when messages are received, their benefits coming out of consensus participation are decayed. By doing so, such actors then lose the opportunity for better compensation.

In respect of the principle to operate the consensus, the present invention uses a hybrid between Proof of Stake, Proof of Location, Proof of Validity and reputation as a model to avoid issues of malicious feeders. The general method steps of implementing such a system is as follows:
1. First of all, a feeder buys an AK-Rx device for FIAT currency and registers to a digital/self-sovereign identity platform (for example, Alastria ID) 151.
2. Secondly, the AK-Rx device is installed at a geographical location and connected to the internet. The geographical location is known at the first connection to the internet through the GNSS chip, and the geographical location is recorded as information for that digital identity.
3. For the purchase of the device, the feeder is entitled access to a consumer web platform to view operations of aircraft, but also is credited a certain amount (“x”) of crypto coins to his wallet.
4. When more than a predetermined number of feeders 3 are feeding the system, they are entitled to “mint” additional currency when “they” run the consensus. It is envisaged that in one implementation, a minimum of four (4) receivers from a certain geographical area need to be involved to run a consensus.
5. The comparison of data is done on the server 7, and all feeders 3 data, not only those that have invested their coins to run the consensus, are considered. However, the feeders that have credited the consensus algorithm are entitled to earn revenue back.
6. Each feeder 3 is entitled to offer a “stake”, and the one which is offering the “most” is the one which will be earning proportionally most, provided the set of information to be checked is confirmed in his feed. The stake is proportional of the coin, multiplied by a reputation factor of the feeder and deducted by the amount of “stake” other feeders bid for the same message(s). The mechanism for rewarding the feeders and the division of the coin/token will be described in more detail with respect to FIG. 5 below.

In addition to the foregoing, it is envisaged that there will be areas where coverage is poor and insufficient feeders are available for consensus. The intent is not to miss/disregard data in areas where coverage is poor. In those cases, where there are insufficient numbers of nodes for a consensus check, but data is being provided by one or more nodes, that data may be provided to the end user on the proviso that it has not been confirmed to be true and the user can use that data at their own risk.

Referring to FIG. 5, there is shown a spreadsheet, indicated by the reference numeral 160, illustrating the rewarding procedure used as part of the consensus management procedure. In one example illustrated by the spreadsheet, a feeder A 161 bids (as illustrated in bid column 171) 50 coins and has a 0.9 reputation factor (as illustrated in reputation factor column 173). Feeders B 163, C 165, D 167 and E 169 have bid 20, 5, 3 and 2 coins respectively, and have reputation factors of 1, 0.7, 0.6, 0.4 respectively. If the reward is 60 coins, the split will be such that the winner, feeder A earns the largest portion of the difference between his “stake” and what is rewarded, however not the highest rate of return to what he has bid.

The reputation factor for the feeder is derived for each feeder based on several conditions, including one or more of the following:
(i) Activity status: depends on the feeder feeding and online status;
(ii) Coverage range: the more the range, the better the status, meaning it is desirable to encourage the feeders to put antenna of the device outside on the roof of their buildings in order to get the best possible reception and increase activity status;
(iii) Total feeds over the rolling month, i.e. the amount of data sent;
(iv) Total confirmed true data without overlaps (i.e. single self-sovereign ID sends same data from two or more devices at different geographical locations, avoiding nesting);
(v) Total consensuses involvement;
(vi) Irrational bids on the “stake”, i.e. a feeder offering 75 coins for a reward of 60 coins;
(vii) Authentication and authorization failures.

Some of the feeders 3 may wish not to get involved in consensus at all, as they simply want to be able to track aircraft and use other perks of the platform. This is entirely legitimate and possible using the method and system according to the invention. Another aspect is that it is intended to make the “Overall bid” a constant and public information, in order to avoid irrational bids.

Considering the game theory, if any of the feeders 3 or groups wanting to spoof the system with false data, will have several obstacles to overcome. For example, each feeder has to set his digital identity, whatever it may be. Each digital identity is in turn linked with a device or devices that have nearly perfect location information of the device. (It is important to note that a single digital identity cannot have message overlap in their feeding, minimizing a chance that a single feeder covers an area of a city or around the airport). Each feeder has a reputation based on above denoted parameters. Each feeder wanting to earn from the platform has to invest a “stake” in order to gain benefit of being the one to mint the coin. All feeds are treated to prove the validity of a certain message, but only the ones that gave a “stake” are eligible to earn benefits. Each feeder has to be rational in his decisions to bid for minting the coin. This part is worthy of further analysis. For example, a group of users may want to block others from being the one to mint a coin. The revenue gained is only the difference between the offered coin, and the offered highest stake. If more than one single feeder bids the same high amount, and the feeders have the same reputation, then the system will apply the Nash equilibrium of prisoners dilemma, and cancel their bids, reducing their reputation and allow the further bids to be rewarded. By doing so, the method and system want to improve the rational behaviour of this economy and allow better protection from malicious groups or individuals.

It will be further understood that various parts of the present invention are performed in hardware and other parts of the invention may be performed either in hardware and/or software. It will be understood that the method steps and various components of the present invention will be performed largely in software and therefore the present invention extends also to computer programs, on or in a carrier, comprising program instructions for causing a computer or a processor to carry out steps of the method or provide functional components for carrying out those steps. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier.

It will be further understood that the present invention may be performed on two, three or more devices with certain parts of the invention being performed by one device and other parts of the invention being performed by another device. The devices may be connected together over a communications network. The present invention and claims are intended to also cover those instances where the system and/or method is operated across two or more devices or pieces of apparatus located in one or more locations. The apparatus and the locations may be in the same or different jurisdictions.

In this specification the terms “comprise, comprises, comprised and comprising” and the terms “include, includes, included and including” are all deemed interchangeable and should be afforded the widest possible interpretation.

The invention is not limited solely to the embodiments hereinbefore described but may be varied in both construction and detail within the scope of the appended claims.

1. A method of providing reliable aircraft information from air band data comprising the steps of: providing a plurality of ground-based nodes, each of which is operable to receive air band data from an aircraft within the ground-based nodes reception range, and a server in communication with each of the ground-based nodes over a communications network; the method further comprising the steps of:
registering each of the ground-based nodes with the server;
authenticating each of the ground-based nodes with the server;
authorizing communication of each of the ground-based nodes with the server;
relaying air band data received from an aircraft at a plurality of the ground-based nodes to the server;
the server, using a consensus algorithm, performing a consensus check on the received air band data received from the plurality of the ground-based nodes;
storing the air band data that has passed the consensus check in a blockchain;
making the air band data stored in the blockchain available for display to end users.

2. The method of providing reliable aircraft information from air band data as claimed in claim 1 in which the method further comprises the step of preforming a reputation check of a ground-based node based on the message truthfulness in comparison to other node's data and reception range.

3. The method of providing reliable aircraft information from air band data as claimed in claim 1 in which the step of storing the air band data that has passed the consensus check in a blockchain further comprises hashing the air band data and storing the message hash in the blockchain; and thereafter making the hash of the air band data available for display to end users.

4. The method of providing reliable aircraft information from air band data as claimed in claim 1 in which the consensus check performed on the received air band data further comprises at least one of (i) a location check on the received air band data; and (ii) an identity check on a feeder of the air band data.

5. (canceled)

6. The method of providing reliable aircraft information from air band data as claimed in claim 1 in which the step of making the air band data stored in the blockchain available for display to end users comprises providing a web application and a web page populated with at least some of the air band data.

7. The method of providing reliable aircraft information from air band data as claimed in claim 5 in which the method comprises providing a plurality of web pages each populated with at least some of the air band data and providing access to one or more of the web pages to different end users.

8. The method of providing reliable aircraft information from air band data as claimed in claim 6 in which the method comprises plotting the location data on a map for subsequent display on an end user's user interface.

9. The method of providing reliable aircraft information from air band data as claimed in claim 1 in which the method comprises the step of transmitting encoded air band data to the server and thereafter decoding the air band data received at the server prior to performing a consensus check on the received air band data.

10. The method of providing reliable aircraft information from air band data as claimed in claim 1 in which the step of using a consensus algorithm to perform a consensus check on the received air band data comprises comparing reception of the air band data under pre-defined conditions for time reception.

11. The method of providing reliable aircraft information from air band data as claimed in claim 1 in which the step of authenticating each of the ground based nodes with the server comprises implementing a self-sovereign identity technique.

12. The method of providing reliable aircraft information from air band data as claimed in claim 1 in which the received air band data comprises at least one of (i) both ACARS and ADS-B band data; and (ii) radio data other than ACARS and ADS-B band data.

13. (canceled)

14. A system for providing reliable aircraft information from air band data comprising:
a plurality of geographically-spread ground-based nodes, each ground-based node having an air band receiver for receiving air band data, means for providing a geolocation of the node, a transmitter for transmitting received air band data to a remote server over a communication network;
a server having: a receiver for receiving the air band data from each of the plurality of geographically-spread ground-based nodes over the communication network; a processor for processing the air band data including, using a consensus algorithm module, performing a consensus check on the received air band data received from a plurality of the ground-based nodes to authenticate the air band data;
a blockchain for storage of the authenticated air band data;
a web application for relaying the authenticated air band data to an end user for display on an end user device.

15. The system for providing reliable aircraft information from air band data as claimed in claim 14 in which the server further comprises means to perform a reputation check of a ground-based node based on the message truthfulness in comparison to other node's data and reception range.

16. The system for providing reliable aircraft information from air band data as claimed in claim 14 in which the server has one or more of (i) a hashing algorithm module for hashing the air band data prior to storage of the hashed authenticated air band data in the blockchain; (ii) a decoder for decoding the received air band data; and (iii) an identity module for verifying the identity of a feeder of air band data.

17. (canceled)

18. (canceled)

19. The system for providing reliable aircraft information from air band data as claimed in claim 14 in which the identity module uses a self-sovereign identity technique to identify the feeder of air band data.

20. The system for providing reliable aircraft information from air band data as claimed in claim 14 in which the consensus algorithm module further comprises a location confirmation module.

21. The system for providing reliable aircraft information from air band data as claimed in claim 14 in which there are provided a plurality of web pages, each populated with at least some of the air band data and there is provided means to selectively provide access to one or more of the web pages to different end users.

22. The system for providing reliable aircraft information from air band data as claimed in claim 14 in which there is provided means to plot the location data on a map for subsequent display on an end user's user interface.

23. The system for providing reliable aircraft information from air band data as claimed in claim 14 in which the air band receiver is a multi-band air band receiver operable to receive at least one of (i) ACARS and ADS-B band data; and (ii) radio data other than ACARS and ADS-B band data.

24. (canceled)

25. The system for providing reliable aircraft information from air band data as claimed in claim 14 in which the means for providing the geolocation of the node comprises one or more of a global navigation satellite system (GNSS) chip and a Wi-Fi based location service.
